(19) United States
(12) Patent Application Publication
(10) Pub. No.: US 2026/0130513 A1
(43) Pub. Date: May 14, 2026

(54) TIME BASED LOUNGE CHAIR COVER SYSTEM

(71) Applicant: Gary Dennis Dinman, Sparks, NV (US)

(72) Inventor: Gary Dennis Dinman, Sparks, NV (US)

(21) Appl. No.: 18/946,279

(22) Filed: Nov. 13, 2024

(51) Int. Cl. A47C 7/62; A47C 1/14; G09F 3/00; G09F 3/02; G09F 3/20

(52) U.S. Cl. CPC A47C 7/386; A47C 1/143; G09F 3/0297; G09F 3/20; G09F 2003/0202

(57) ABSTRACT

A Time-based system for using the lounge chair for a specified amount of time including a lounge chair cover configured to fit over a portion of a lounge chair. The lounge chair system also includes a pocket coupled to the lounge chair cover. The lounge chair system includes the custom card comprising at least one writable area. The writable area is utilized to write a time when the user of the chair will return to the lounge chair.

### FIELD

The present disclosure relates to seat covers.

### BACKGROUND

Lounge chairs are popular on cruise ships and at beach resorts. To reserve and hold them, people often put their belongings on them. Often, people will leave their belongings on the lounge chairs for long periods of time, not allowing others to use them.

As can be seen, there is a need for a device that addresses the above drawbacks.

### SUMMARY

In one aspect of the present disclosure, a time-based chair cover system including a lounge chair cover configured to fit over a portion of a lounge chair. The chair cover system also includes a pocket coupled to the lounge chair cover. The chair cover system includes a custom card comprising at least one writable area. The writable area is utilized to write a time for that the lounge chair has been vacant so both the staff and any potential guests that want to use the chair will know when the previous user will return.

In another aspect of the present disclosure, the method includes attaching a lounge chair cover to a portion of a lounge chair. The lounge chair cover is configured to fit over a portion of the lounge chair. The method includes inserting a card from a pocket coupled to the lounge chair cover. Further, the method includes writing a return time on the card with the dry erase marker. The method includes inserting the card into the pocket.

### BRIEF DESCRIPTION OF THE DRAWINGS

FIG. 1 is a perspective view of a lounge chair cover in use, according to aspects of the present disclosure;

FIG. 2 is a detailed perspective view of the lounge chair cover, according to aspects of the present disclosure;

FIG. 3 is an exploded view of the lounge chair cover, according to aspects of the present disclosure;

FIG. 4 is a front view of the lounge chair cover in use, according to aspects of the present disclosure;

FIG. 5A is a front view of the custom card, according to aspects of the present disclosure;

FIG. 5B is a rear view of the custom card, according to aspects of the present disclosure; and

FIG. 6 is a flow chart of a method using the lounge chair cover, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a lounge chair cover and a time-based system to allow all parties to know when the chair user will return if the chair is unoccupied. The lounge chair has a custom pocket that holds a custom card. The card can include pre-printed text, and with a dry-erase marker, the chair user can write messages and a time when they will return.

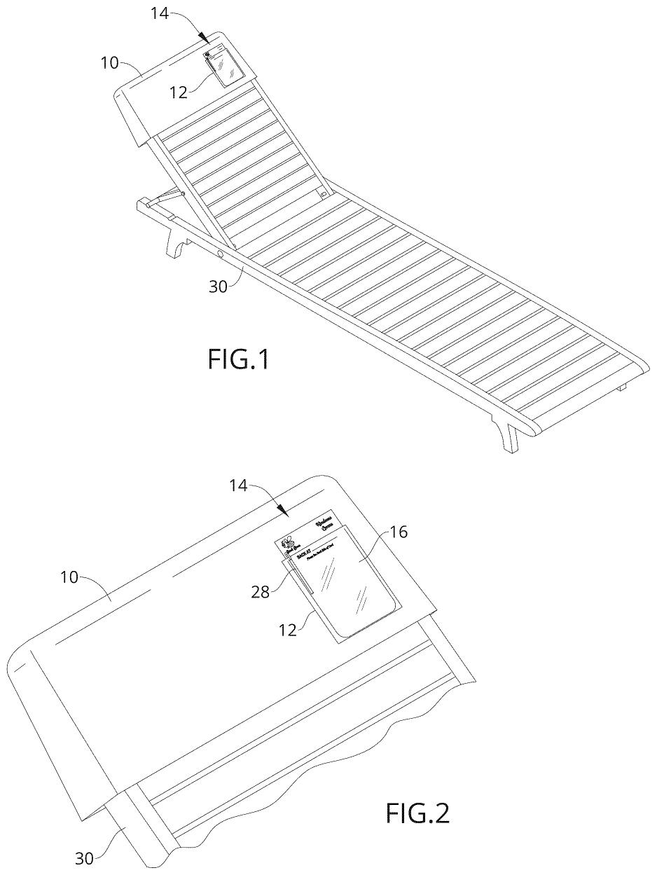

Referring now to FIGS. 1-4, 5A, 5B and 6, FIG. 1 illustrates a lounge chair cover 10, according to aspects of the present disclosure. While FIG. 1 illustrates examples of components of the lounge chair cover 10, additional components can be added and existing components can be removed and/or modified.

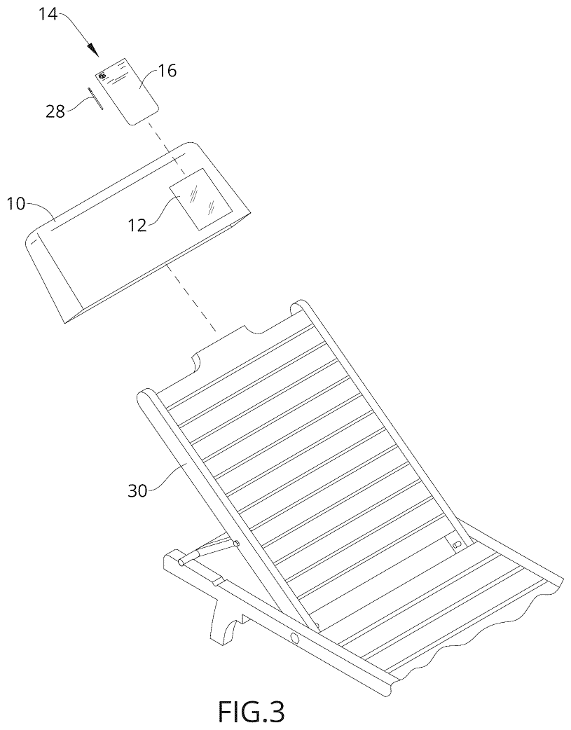

As illustrated in FIG. 1, the lounge chair cover 10 is adapted to be fitted over a lounge chair 30. The lounge chair cover 10 is configured to fit over a portion of the lounge chair 30, for example, the back of the lounge chair 30. For example, the lounge chair cover 10 can have an approximately rectangular shape with a front and back side that defines a cavity. One side of the lounge chair cover 10 is open allowing access to the cavity. The Lounge chair cover 10 can be fitted onto the lounge chair 30 by sliding the back of the lounge chair 30 into the cavity through the opening, as illustrated in FIG. 3.

In embodiments, the lounge chair cover 10 is constructed of a flexible and stretchable material that allows the lounge chair cover 10 to securely fit on the lounge chair 30. For example, lounge chair cover 10 can be constructed of a polyester and Spandex blend such as approximately 90 percent polyester and approximately 10 percent Spandex to add extra utility for the users preferred use.

As further illustrated in FIG. 2, the lounge chair cover 10 includes a pocket 12 coupled to one surface of the lounge chair cover 10. For example, the pocket 12 can be coupled to a front side of the lounge chair cover 10 at a side or corner of the lounge chair cover 10. In some embodiments, the pocket 12 can be constructed of the same material as the lounge chair cover 10. For example, the pocket 12 can be constructed of a polyester and Spandex blend such as approximately 90 percent polyester and approximately 10 percent Spandex.

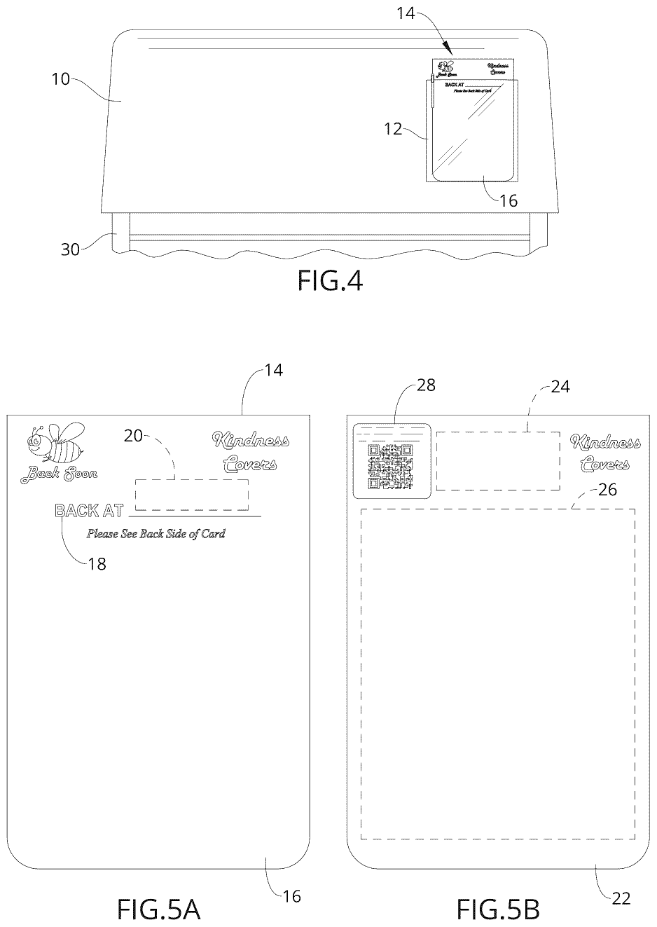

As illustrated in FIG. 4, the pocket 12 is configured to receive a custom card 14. The card 14 operates as a system such that a user can use the lounge chair 30 for a specified amount of time As illustrated in FIGS. 5A and 5B, the card 14 can have front side 16 and a back side 22. The card 14 includes preprinted information that provides details of the cruise line or beach club, e.g., cruise line logo 24, as well as a prompt 18. One or more of the front side 16 or the back side 22 can be made a material that allows messages to be written and erased from the custom card 14, for example, a dry erase material. The card 14 includes an area 20 in which a user can write a return time thereby indicating a time the lounge chair 30 may be in use. The custom card 14 can also include one or more machine-readable codes, e.g., bar code, QR code, etc., that allow the user to access additional information, such as a menu, a list of events, etc., using a computing device. A writing implement 28, e.g., a dry-erase marker, can be also inserted into the pocket 12 and/or coupled to the pocket 12 and/or the lounge chair cover 10.

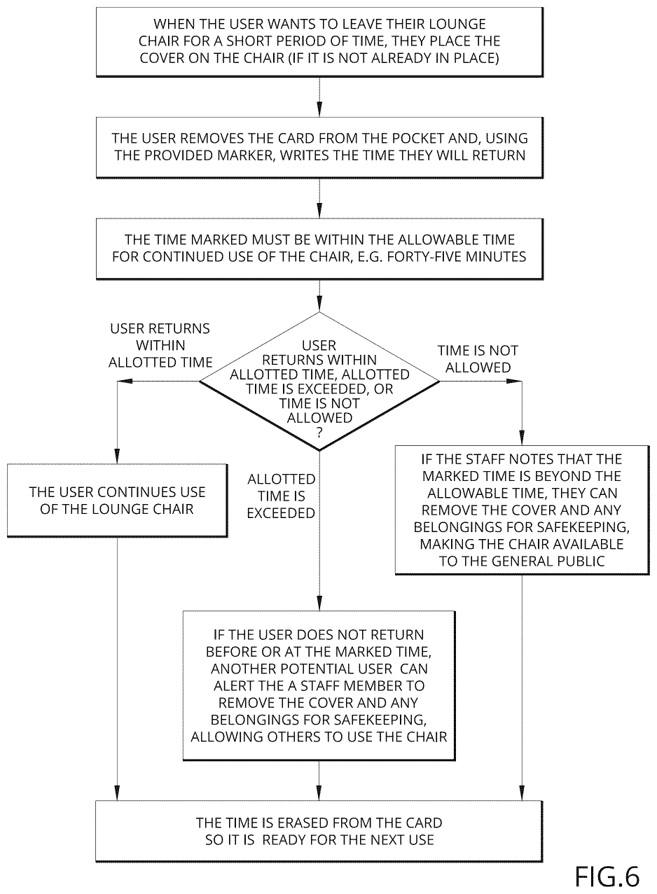

FIG. 6 illustrates a method for using the lounge chair cover 10. When a user wants to leave their lounge chair for a short period of time, the user can place the lounge chair cover 10 on the chair, if not already in place. The user then removes the card from the pocket 12 and, using the writing implement 28, writes a return time on the card 14. The time marked on the card 14 can be within an allowable time for continued use of the chair, e.g., set by the cruise line or beach club. If the return time is within the allowed time and the user returns before the expiration of the return time, the user can continue to use the chair. If the allotted time is exceeded or the return time is now within the allowed time, a staff member can remove the lounge chair cover 10 and any belongings of the user, and the chair can be made available for use.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A chair cover system, comprising:
a lounge chair cover configured to fit over a portion of a lounge chair;
a pocket coupled to the lounge chair cover; and
a custom card comprising at least one writable area, wherein the writable area is utilized to write a time when one will return to the lounge chair.

2. The chair time-based system of claim 1, further comprising:
a writing implement configured to write on the custom card.

3. The chair cover system of claim 1, wherein the lounge chair cover comprises:
a front surface;
a back surface coupled to the front surface, wherein the front surface and the back surface define a cavity; and
an opening providing access to the cavity, wherein the cavity is configured to be fitted over a portion of the lounge chair.

4. The chair cover system of claim 3, wherein the lounge chair cover is constructed of a flexible material.

5. The chair cover system of claim 4, wherein the flexible material is a blend of polyester and Spandex.

6. The chair cover system of claim 1, wherein the custom card comprises:
a front surface including the writable area; and
a back surface.

7. The chair cover system of claim 6, wherein the custom card further comprises:
a machine-readable code printed on the front surface or the back surface.

8. The chair cover system of claim 7, wherein the writable area is formed of dry erase material.

9. The chair cover system of claim 1, wherein the pocket is constructed of a same as the lounge chair cover.

10. A time-based method of using the lounge chair, the method comprising:
attaching a lounge chair cover to a portion of a lounge chair, wherein the lounge chair cover is configured to fit over a portion of the lounge chair;
removing the custom card from a pocket coupled to the lounge chair cover; and
writing a return time on the custom card; and
inserting the card into the pocket.
